(19) United States
(12) Patent Application Publication
(10) Pub. No.: US 2005/0152393 A1
(43) Pub. Date: Jul. 14, 2005

(54) Method of establishing connection between wireless communication devices

(76) Inventor: Wen-Chih Lin, SanChung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/755,305

(22) Filed: Jan. 13, 2004

(51) Int. Cl. H04J 3/16

(52) U.S. Cl. 370/437; 370/395.53

(57) ABSTRACT

A method of establishing a connection between wireless communication devices, in which a VPN (virtual private network) is established between the wireless communication devices for message transmission. After the connection procedure being started, a first wireless communication device obtains a first address code and a first gateway code from a first base station, and a second wireless communication device obtains a second address code and a second gateway code. Then, the first wireless communication device selects an operating mode, and a first message-transmitting code is generated in the first wireless communication device while a second message-transmitting code is generated in the second wireless communication device. The first wireless communication device transmits the first message-transmitting code to the second wireless communication device via PSTN (Public Switched Telephone Network), and the second wireless communication device compares the first message-transmitting code and the second message-transmitting code to determine whether to accept the message transmission. Finally, a VPN is established and messages are transmitted via this VPN connection if the second message-transmitting code accepts the message transmission.

### BACKGROUND OF THE INVENTION

1. Field of the Invention

The invention relates to a method of establishing a connection between wireless communication devices, in which a VPN (virtual private network) is established between the wireless communication devices for message transmission.

2. Description of the Related Art

The development of wireless communication not only brings convenience to our life but also results in the changes of our habits. Using wireless communication devices, problems require long-time negotiation in the past may be solved quickly, decisions may be made in a shorter time, and questions may be responded more promptly. Therefore, wireless communication has become an inseparable part of our modem life in which speed is heavily emphasized.

FIG. 1 is a schematic diagram illustrating the architecture of establishing a connection within a conventional wireless communication system. Please refer to FIG. 1, in which two wireless communication devices 20 and 21 are illustrated. When the first wireless communication device 20 requests the second wireless communication device 21 to establish a connection, it transmits a request message to a first base station 10. Then, the first base station 10 establishes a communication connection with a second base station to which the second wireless communication device 21 belongs via PSTN (Public Switched Telephone Network) 1. After the second wireless communication device 21 accepts the connection request from the first wireless communication device 20, a communication channel is established for verbal communication. This communication channel thus occupies the resource of PSTN.

The above illustrated the establishment of a verbal communication channel between wireless communication devices. As for message transmission, the development of wireless communication system gradually evolves from the second-generation GSM (Global System for Mobile Communication) system into the third-generation CDMA (Code Division Multiple Access, CDMA) system. Among GSM system, CDMA system, and the transitional GPRS (General Package Radio Service) system, the communication signal processing speed of CDMA system is no doubt the fastest. However, the third-generation communication protocol still has many problems that needs to be solved and improved when transmitting messages between two wireless communication device.

The most critical problem of the third-generation CDMA protocol is its instability. Although ideally the transmission speed may reach megabit per second, practically it may reduce far less than megabit per second due to the effect of transmission medium, the weather condition, or the excess number of users. Sometimes it may even reduce to kilobit per second. Not to say the second-generation GSM system or the 2.5-generation GPRS system, their transmission speeds are even slower and thus cannot satisfy the user needs.

### SUMMARY OF THE INVENTION

In view of the above, an objective of the invention is to provide a method of wireless communication, in which messages can be transmitted faster between wireless communication devices.

To achieve the above objectives, the invention discloses a method of establishing a connection between wireless communication devices, in which a VPN (virtual private network) is established between the wireless communication devices for message transmission. According to the invention, after the connection procedure being started, a first wireless communication device obtains a first address code and a first gateway code from a first base station, and a second wireless communication device obtains a second address code and a second gateway code. Then, the first wireless communication device selects an operating mode, and a first message-transmitting code is generated in the first wireless communication device while a second message-transmitting code is generated in the second wireless communication device. The first wireless communication device transmits the first message-transmitting code to the second wireless communication device via PSTN (Public Switched Telephone Network), and the second wireless communication device compares the first message-transmitting code and the second message-transmitting code to determine whether to accept the message transmission. Finally, a VPN is established and messages are transmitted via this VPN connection if the second message-transmitting code accepts the message transmission.

In one embodiment of the invention, the first message-transmitting code may include a first identification code, a first machine code, a first address code, a first gateway code, a first transmission machine code, a default code, and a default gateway code. The first identification code is generated by the first wireless communication device for operating mode selection. The first machine code is an identification number of the first wireless communication device. The first address code is an identification address assigned by the first base station to the first wireless communication device. The first gateway code is a gateway address assigned by the first base station to the first wireless communication device. The first transmission machine code is another identification number of the second wireless communication device. The default code is generated by the first wireless communication device. The default gateway code is a null gateway address generated by the first wireless communication device.

Similarly, according to the embodiment, the second message-transmitting code may include a second identification code, a second machine code, a second address code, a second gateway code, a second transmission machine code, a return code, and a return gateway code. The second identification code is generated by the second wireless communication device to respond to the first wireless communication device whether to accept the selection of the operating mode. The second machine code is an identification number of the second wireless communication device. The second address code is an identification address assigned by the second base station to the second wireless communication device. The second gateway code is a gateway address assigned by the second base station to the second wireless communication device. The second transmission machine code is the identification number of the first wireless communication device. The return code is an identification address of the first wireless communication device. The return gateway code is the gateway address of the first wireless communication device. The return code may be the first address code, and the return gateway code may be the first gateway code.

In the embodiment, after the step of confirming the identification information, the second wireless communication device may return the second message-transmitting code to the first wireless communication device, and the first wireless communication device may update the content of the first message-transmitting code. The step of updating the first message-transmitting code updates the content of the default code to the second address code, and updates the default gateway code to the second gateway code

Since messages are transmitted via VPN connection instead of PSTN connection, the invention can enhance the data transmission speed by establishing VPN connections while keep the functionality of verbal communication via PSTN.

### BRIEF DESCRIPTION OF THE DRAWINGS

FIG. 1 is a schematic diagram showing the architecture of wireless communication in the prior art.

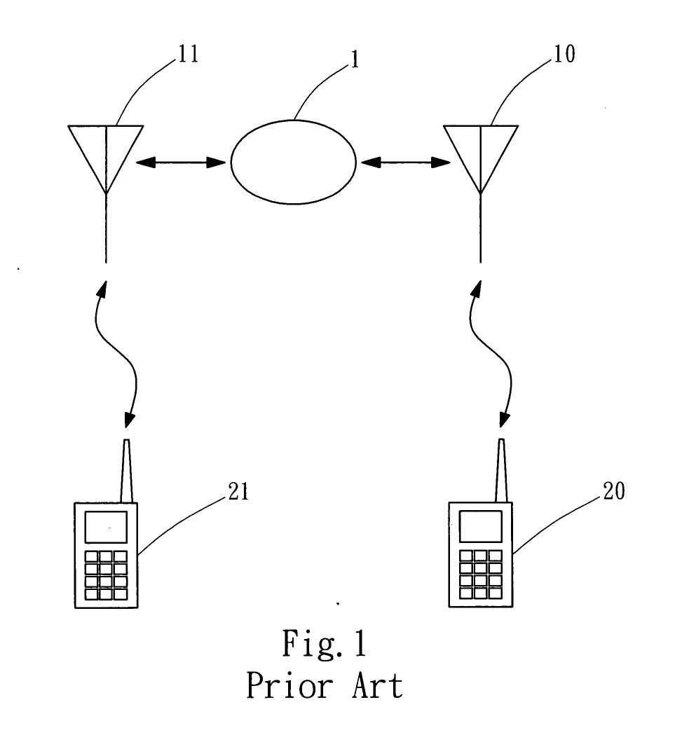

FIG. 2 is a flowchart showing the steps of establishing a signal connection between wireless communication devices according to an embodiment of the invention.

FIG. 3 is a schematic diagram illustrating the signal transmission according to the embodiment of the invention.

FIG. 4 is a schematic diagram showing the format and content of the message-transmitting codes during the connection of the wireless communication devices.

### DETAILED DESCRIPTION OF THE PREFERRED EMBODIMENT

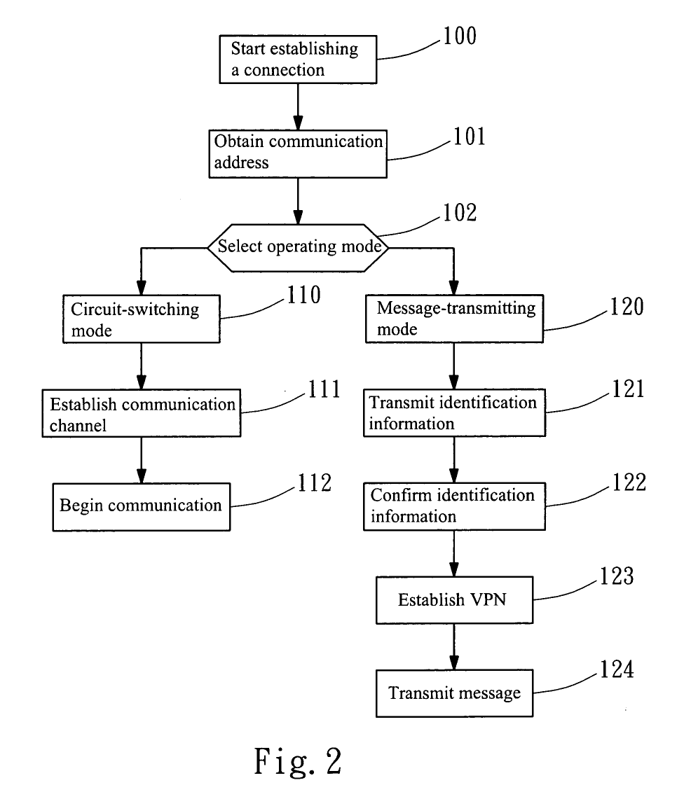

Please refer to FIG. 2, which is a flowchart showing the steps of establishing a connection between wireless communication devices according to an embodiment of the invention. After the process has started, that is, after the step 100 of start connecting as shown in FIG. 2 is performed, the wireless communication device obtains the communication address at step 101 from the base station it belongs to. The address includes an address code and a gateway code. After the wireless communication device obtained the assigned address, step 102 is performed to select an operating mode. In this step, the wireless communication device selects whether the subsequent operating mode be the circuit-switching mode or the message-transmitting mode.

In the prior art, the conventional verbal communication mode is the circuit-switching mode. When the wireless communication device selects the operating mode to be the circuit-switching mode 110 in the operating mode-selecting step 102, the communication channel-establishing step 111 is performed. Then, a communicating step 112 between the base station and the PSTN (Public Switched Telephone Network) is performed. The circuit-switching mode operations are prior-art techniques, and the relevant detailed descriptions are omitted here for concise purpose.

When the wireless communication device confirms to execute another operating mode, that is, the message transmitting mode 120 in the operating mode-selecting step 102, the wireless communication device then generates a message-transmitting signal, and transmits identification information to another wireless communication device via this message-transmitting signal (step 121). The other wireless communication device generates another message-transmitting signal and confirms the identification information (step 122). After the other wireless communication device confirming the identification information, a VPN (Virtual Private Network) is established between the two wireless devices for message transmission (step 123).

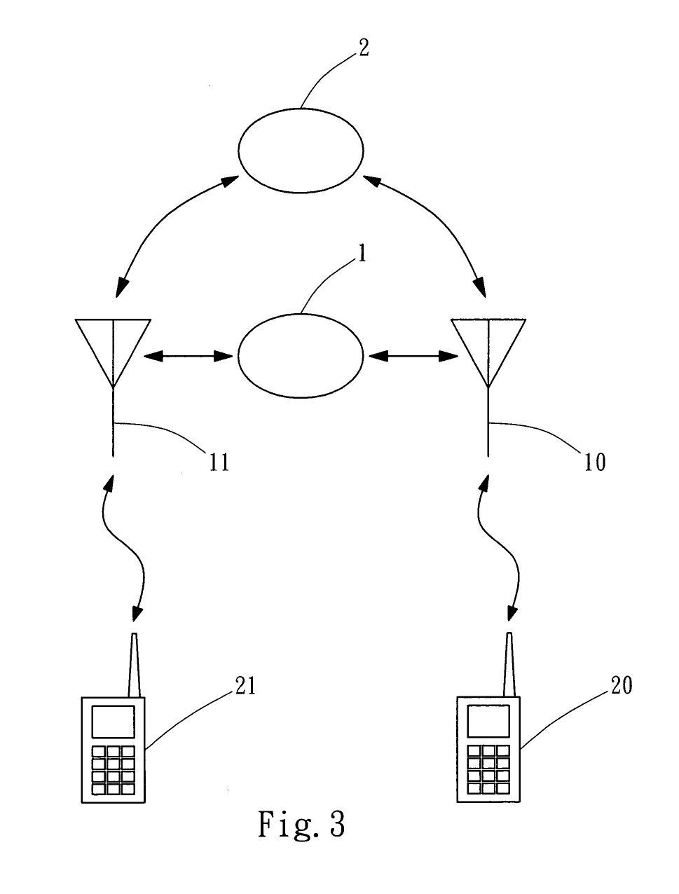

Please refer to FIG. 3, which is a schematic diagram showing the signal transmission scheme according to the embodiment of the invention. After the operation being initiated, a first wireless device 20 sends a message-transmitting signal to a first base station 10, and the first base station 10 sends the message-transmitting signal to a second wireless communication device 21 via the PSTN 1 and a second base station 11. Then, the second wireless communication device 21 confirms the identification information contained in the message-transmitting signal. After the second wireless communication device 21 confirming and accepting the message transmission, it returns another confirmed message-transmitting signal using the second base station 11 via the PSTN 1 and the first base station 10, and thus establishes a VPN 2 between the first base station 10 and the second base station 11 for message transmission.

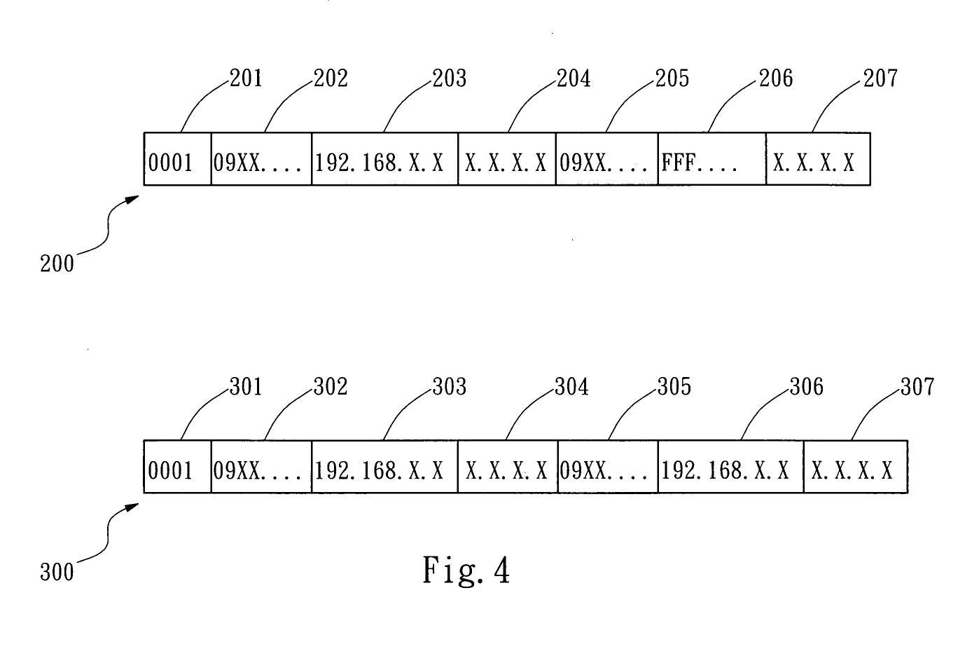

Please refer to FIG. 4, which is a schematic diagram showing the format of the transmitted codes contained in the message-transmitting signal between two wireless communication devices. The first message-transmitting code 200 is contained in the message-transmitting signal sent by the first wireless communication device, which code including a first identification code 201, a first machine code 202, a first address code 203, a first gateway code 204, a first transmission machine code 205, a default code 206, and a default gateway code 207.

The first identification code 201 is generated by the first wireless communication device for the selection of the operating modes. It may have different aspects for the wireless communication device to choose which operating mode to execute. The first machine code 202 is an identification number of the first wireless communication device, which may be a so-called telephone number. The first address code 203 is assigned by the first base station, and is provided to the first wireless communication device together with the first gateway code 204 for address identification purpose after the VPN is established. The first t transmission machine code 205 is the identification number of the second wireless communication device, which may be the so-called telephone number of the second wireless communication device. The default code 206 and the default gateway code 207 is generated by the first wireless communication device, so that the first message-transmitting code 200 can be transmitted to the second wireless communication device completely after the beginning of the signal transmission. The above are the format and content of the first message-transmitting code 200.

Similar to the first message-transmitting code 200, the second message-transmitting code 300 is generated by the second wireless communication device, and includes a second identification code 301, a second machine code 302, a second address code 303, a second gateway code 304, a second transmission machine code 305, a return code 306, and a return gateway code 307. Below are descriptions regarding the contents of the second message-transmitting code 300.

The second identification code 301 is generated by the second wireless communication device to examine and confirm whether the selection of the operating mode by the first wireless communication device is accepted. The second machine code 302 is the identification number of the second wireless communication device, which is similar to the so-called telephone number. The second address code 303 is assigned by the second base station, and is provided to the second wireless communication device together with the second gateway code 304 for address identification purpose after the VPN is established. The second transmission machine code 305 is the identification number of the first wireless communication device. The return code 306 and the return gateway code 307 are the identification addresses of the first wireless communication device, which are address codes generated internally after receiving the first message-transmitting code 200. That is, after receiving the first address code 203 and the first gateway code 204 included in the first message-transmitting code 200, the second wireless communication device would update the return code 306 and return gateway code 307 included in the second message-transmitting code 300 to obtain the same addresses. The above are the format and content of the second message-transmitting code 300.

Although the format and content of the first message-transmitting code 200 and the second message-transmitting code 300 have been described above, to further clarify the technique of the invention, the steps of the embodiment will be further explained below. The first message-transmitting code 200 and the second message-transmitting code 300 are generated by the operation procedures executed by the microprocessors and the memories provided in the first wireless communication device and the second wireless communication device. The operation procedures are built-in in the memories. During the operation, the second wireless communication device executes the update process of the second message-transmitting code 300 after receiving the first message-transmitting code 200. After the step of confirming the identification information, the second wireless communication device returns the updated second message-transmitting code 300 to the first wireless communication device. Subsequently, the first wireless communication device updates the contents of the first message-transmitting code 200.

As mentioned previously, in the format and content of the second message-transmitting code 300, the return code 306 and the return gateway code 307 are the same as the first address code 203 and the first gateway code 204. This is the result of the operation procedure being executed by the microprocessor and the memory of the second wireless communication device. Similarly, the reason why the second transmission machine code 305 is the same as the first machine code 202 is that it is the result of the operation procedure being executed y the microprocessor and the memory. Moreover, using its microprocessor and memory, the first wireless communication device processes the second message-transmitting code 300 returned from the second wireless communication device, and updates to continuously transmit another first message-transmitting code 200. The update is to change the default code 206 and the default gateway code 207 of the first message-transmitting code 200 into the second address code 303 and the second gateway code 304.

After being updated by the operation procedures executed by the microprocessors and the memories, the first message-transmitting code 200 and the second message-transmitting code 300 are keep transmitted by the first wireless communication device and the second wireless communication device. As shown in FIG. 3, the VPN is established in cooperation with the first base station and the second base station. Afterward, the messages are transmitted via the established VPN.

To sum up, the method of connecting the wireless communication devices can enhance the data transmission speed by establishing VPN connections while keep the functionality of verbal communication.

The above descriptions are exemplary and should not be construed in a limiting sense. Any change and modification without departing from the spirit and scope of the invention should be incorporated in the appended claims.

1. A method of establishing a connection between wireless communication devices, in which a VPN (virtual private network) is established between the wireless communication devices for message transmission, the method comprising the steps of:
starting to establish connection,
obtaining communication addresses, wherein a first wireless communication device obtains a first address code and a first gateway code from a first base station, and a second wireless communication device obtains a second address code and a second gateway code;
selecting an operating mode, wherein the first wireless communication device selects an operating mode to be one of a circuit-switching mode and a message-transmitting mode;
executing the message-transmitting mode, wherein a first message-transmitting code is generated in the first wireless communication device, and a second message-transmitting code is generated in the second wireless communication device;
transmitting identification information, wherein the first wireless communication device transmits the first message-transmitting code to the second wireless communication device via PSTN (Public Switched Telephone Network);
confirming the identification information, wherein the second wireless communication device compares the first message-transmitting code and the second message-transmitting code to determine whether to accept the message transmission; and if yes,
establishing the VPN and transmitting a message via the VPN.

2. The method according to claim 1, wherein the first message-transmitting code generated by the first wireless communication device includes:
a first identification code generated by the first wireless communication device for operating mode selection;
a first machine code, which is an identification number of the first wireless communication device;
a first address code , which is an identification address assigned by the first base station to the first wireless communication device;
a first gateway code, which is a gateway address assigned by the first base station to the first wireless communication device;
a first transmission machine code, which is another identification number of the second wireless communication device;
a default code generated by the first wireless communication device; and
a default gateway code, which is a null gateway address generated by the first wireless communication device.

3. The method according to claim 1, wherein the second message-transmitting code generated by the second wireless communication device includes:
a second identification code generated by the second wireless communication device to respond to the first wireless communication device whether to accept the selection of the operating mode;
a second machine code, which is an identification number of the second wireless communication device;
a second address code , which is an identification address assigned by the second base station to the second wireless communication device;
a second gateway code, which is a gateway address assigned by the second base station to the second wireless communication device;
a second transmission machine code, which is an identification number of the first wireless communication device;
a return code, which is an identification address of the first wireless communication device; and
a return gateway code, which is the gateway address of the first wireless communication device.

4. The method according to claim 3, wherein the return code is the first address code, and the return gateway code is the first gateway code.

5. The method according to claim 1, wherein after the step of confirming the identification information, the second wireless communication device returns the second message-transmitting code to the first wireless communication device, and the first wireless communication device updates content of the first message-transmitting code.

6. The method according to claim 5, wherein the step of updating the first message-transmitting code updates content of a default code to the second address code, and updates a default gateway code to the second gateway code.

7. The method according to claim 1, wherein the first wireless communication device communicates with the PSTN via the first base station, and the PSTN communicates with the second wireless communication device via the second base station.

8. The method according to claim 1, wherein the first wireless communication device communicates with the VPN via the first base station, and the VPN communicates with the second wireless communication device via the second base station.

9. The method according to claim 1, wherein in the step of selecting the operating mode, the first wireless communication device and the second wireless communication device establish a communication channel via the first base station and the second base station respectively and communicate with each other via the PSTN when the circuit-switching mode is selected.

10. A wireless communication connection device, which executes the following procedures using a microprocessor and a memory inside a wireless communication device:
starting to establish connection,
obtaining communication addresses, wherein at least one base station assigns address codes and gateway codes to a plurality of wireless communication devices;
selecting an operating mode, wherein a first wireless communication device selects and executes one of a circuit-switching mode and a message-transmitting mode;
when executing the message-transmitting mode, transmitting an identification information from the first wireless communication device to a second wireless communication device, wherein the identification information is a first message-transmitting code;
confirming the identification information, wherein the second wireless communication device returns the identification information to the first wireless communication device after confirming the first message-transmitting code received, wherein the identification information returned is a second message-transmitting code; and
establishing a VPN and directly transmitting a message via the VPN.

11. The wireless communication connection device according to claim 10, wherein the first message-transmitting code includes:
a first identification code for operating mode selection;
a first machine code, which is an identification number of the first wireless communication device;
a first address code , which is an identification address assigned by the first base station to the first wireless communication device;
a first gateway code, which is a gateway address assigned by a first base station to the first wireless communication device;
a first transmission machine code, which is another identification number of the second wireless communication device;
a default code; and
a default gateway code, which is a null gateway address generated by the first wireless communication device.

12. The wireless communication connection device according to claim 10, wherein the second message-transmitting code generated by the second wireless communication device includes:
a second identification code for responding to the first wireless communication device whether to accept a selection of the operating mode;
a second machine code, which is an identification number of the second wireless communication device;
a second address code , which is an identification address assigned by the base station to the second wireless communication device;
a second gateway code, which is a gateway address assigned by the base (Note: lack of antecedent basis) station to the second wireless communication device;
a second transmission machine code, which is an identification number of the first wireless communication device;
a return code, which is an identification address of the first wireless communication device; and
a return gateway code, which is a gateway address of the first wireless communication device.

13. The wireless communication connection device according to claim 12, wherein the return code is a first address code, and the return gateway code is a first gateway code.

14. The wireless communication connection device according to claim 10, wherein after the step of confirming the identification information, the second wireless communication device returns the second message-transmitting code to the first wireless communication device, and the first wireless communication device updates the content of the first message-transmitting code.

15. The wireless communication connection device according to claim 14, wherein the step of updating the first message-transmitting code updates content of a default code to a second address code, and updates a default gateway code to a second gateway code.

16. The wireless communication connection device according to claim 10, wherein the first wireless communication device communicates with the PSTN through via the base station, and the PSTN communicates with the second wireless communication device via another base station.

17. The wireless communication connection device according to claim 10, wherein the first wireless communication device communicates with the VPN via the base station, and the VPN communicates with the second wireless communication device via another base station.

18. The wireless communication connection device according to claim 10, wherein in the step of selecting the operating mode, the first wireless communication device and the second wireless communication device establish a communication channel via the base station and another base station respectively and communicate with each other via the PSTN when the circuit-switching mode is selected.
